(19) United States
(12) Patent Application Publication
(10) Pub. No.: US 2010/0071487 A1
(43) Pub. Date: Mar. 25, 2010

(54) SELF CONTAINED HYDRAULIC SYSTEM FOR A REMOTE CONTROLLED UNIT

(75) Inventors: Charles Bradley Kampbell, Ammon, ID (US); Anthony Addison Peck, Idaho Falls, ID (US)

Correspondence Address: DARBY & DARBY P.C., P.O. BOX 770, Church Street Station, New York, NY, 10008-0770, US

(73) Assignee: Revolution Mechanical Works, LLC, Idaho Falls, ID (US)

(21) Appl. No.: 12/235,358

(22) Filed: Sep. 22, 2008

(51) Int. Cl. G01M 19/00

(52) U.S. Cl. 73/865.8

(57) ABSTRACT

A remotely controlled unit providing three degrees of actuation (rotational, perpendicular to a long axis, parallel to a long axis) of a variety of attachments to assist in the inspection, measurement, lining, and repair of pipe lines. The degrees of actuation are accomplished using a hydraulic system having a hydraulic pump, reservoir, solenoid actuated automatic valves, pistons, and cylinders inside the body of the unit. The components are designed to operate in a partially to fully submersed environment. The unit has an on board camera system that allows an operator the ability to monitor the attachments. In addition to the degrees of actuation, the unit carries a hydraulic clamp that secures the robot in the pipe during its various operations. The unit is controlled and cameras viewed through a control cable that connects the unit to an above ground control station consisting of micro control boards controlled by a CPU.

### FIELD OF THE INVENTION

The invention relates to a self-contained hydraulic unit for use in small confined spaces. Specifically, a unit to perform inspection and repair of sewer pipe lines.

### BACKGROUND OF THE INVENTION

There are currently many types of remotely controlled units that are designed to enter enclosed spaces, such as pipe lines, and perform intricate operations. For a pipe line such operations include inspection, cutting, measuring, and lateral installation. To perform the above operations it becomes necessary to have equipment that can enter the pipe and adjust (i.e. three degrees of motion) to line up with the desired location within the pipe. The majority of these units use electrical motors and gears, pneumatic power, hydraulic power, or a combination of the three to provide the motive force to obtain the degrees of actuation desired to perform the adjustments necessary for their application.

Currently, hydraulic systems have only been used on a limited scale due to excessive amount of hydraulic hoses needed to connect the unit to the above ground control system. For example, to actuate a hydraulic system with three dual acting cylinders there needs to be six hydraulic lines connecting the unit to the above ground control station. Since these units typically need to enter pipelines to a length of up to 500 feet the six lengths of hydraulic hose present numerous problems such as cost of hose, amount of hydraulic fluid needed in the reservoir, system pressure needed to overcome head loss throughout the hose, size of hose reels to handle the hose, and the increase in maintenance cost due to hose wear. Further, the remote unit, or its ancillary systems, must generate a considerable amount of forward motion to move itself and the six hoses down the enclosed space.

Additionally, depending on the enclosed space, typical hydraulic fluid may not be acceptable if accidentally released into the enclosed space. The addition of hoses being dragged long distances and the forces exerted on the couplings increase the risk of accidental release. Any spillage or leakage should be minimized or eliminated.

It is the object of this invention to provide a remotely controlled unit for the use inside pipe lines that employees a self enclosed hydraulic system allowing for the hydraulic actuation of at least three degrees of motion with the ability to receive attachments for measuring/inspecting, cutting lateral openings, and deploying lateral lining systems without having to connect hydraulic lines to an above ground control station. Additionally, the hydraulic system should run on environmentally safe (depending on the enclosed environment) hydraulic fluid.

### SUMMARY OF THE INVENTION

Thus, described below is a unit with a self contained hydraulic system that allows at least 3 degrees of motion. The unit consists of the motor housing assembly, the rotational housing assembly, the clamp/camera assembly, and the control system.

The rotational housing assembly is positioned on the front of the unit and provides for the radial and rotational degrees of motion. The housing can be cylindrically shaped and can have a hydraulic rotary actuator mounted within the inner diameter of the housing with its shaft extending beyond the front of the housing. On the front end of the housing is mounted a rotational race. Attached to the rotational race are two mounting forks that in turn attach to the radial slide that is also keyed to the shaft of the rotary actuator. Pinned to the radial slide is an interfacing dovetail piston assembly that allows the extension of the dovetail piston assembly along the length of the slide. The mounting forks provide the reaction force to counteract the weight of the cantilevered attachments that can be attached to the dovetail and the moment force induced when attachments are extended to react with the side wall.

The motor housing is located directly behind the rotational housing. Like the rotational housing, the motor housing can be cylindrical. On the bottom front side of the housing can be mounted a dual rod linear hydraulic piston. The piston is attached to the rotational housing via a half moon linkage bolted to the rear bottom side of the rotational housing. This piston allows the rotational housing to be indexed along the axis of the unit with a range, in one embodiment, of approximately 4 inches. The remainder of the space inside of the motor housing contains the hydraulic system and the camera/laser power system. The hydraulic system consists of a motor/pump/reservoir power unit, solenoid actuated valves, tubing, and appropriate fittings. The camera/laser power system consists of two AC to DC power adapters with interfacing connections. In one embodiment, in the approximate middle of the motor housing there is an approximately 8 inch cut out in the housing that is capped off with a mounting plate upon which is mounted the clamp/camera assembly. On the bottom side of the motor housing is mounted two skis upon which the rotational housing slides and which interface with the sidewall of the pipe in which the unit is being used.

The clamp/camera assembly attaches to the mounting plate attached to the motor housing. The clamp consists of a hydraulic piston driven four bar linkage that is housed in a u-channel housing. On the portion of the four bar linkage that raises there is a horse shoe shaped camera bracket that provides mounting locations for an inspection camera. This design allows the camera to be retracted within the unit to protect it during the deployment of the unit into the pipe.

The unit is controlled through and electrical cable that is attached to a control box above ground. The key elements of the control box are two micro control boards, motor capacitor, power conditioner, and laptop computer. The laptop has the appropriate software to interface with the video cameras and the micro control boards allowing full control of all unit functions.

### BRIEF DESCRIPTION OF THE DRAWING

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a right side view of an embodiment of the unit showing internal components and the outer casing is in phantom;

FIG. 2 is a magnified front right perspective view of the Rotational Housing showing internal components and the interface of the radial piston with the t-slider and the rotary actuator;

FIG. 3 is a bottom view of the Rotational Housing showing internal components;

FIG. 4 is a schematic of the hydraulic system of the present invention;

FIG. 5 illustrates the unit attached to the control box;

FIG. 6 is a magnified view of the clamp assembly showing the internal components; and

FIG. 7 illustrates an embodiment of the unit functioning within an enclosed space.

### DETAILED DESCRIPTION OF THE INVENTION

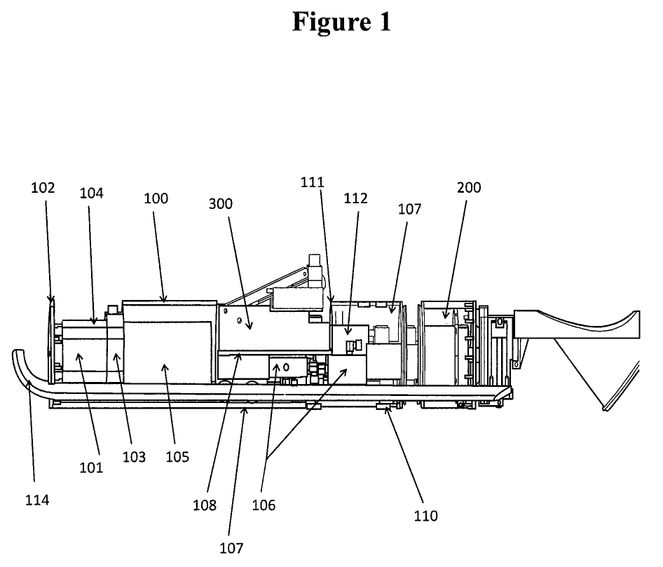

Referring to FIGS. 1-7, a unit 10 embodying the invention is illustrated. The unit 10 includes a motor housing 100, a rotational housing 200, a clamp housing 300, and a control box 400.

The motor housing 100 can be pipe shaped and has an internal diameter. Other embodiments can be shaped to fit the parameters of an enclosed environment. In this embodiment, the motor housing 100 is cylindrical to fit inside a pipe line. Mounted to the front of the motor housing 100 is an end cap 102. The end cap 102 prevents interior components captured within the volume of the housing from exiting the housing. Mounted forward of the end cap 102 is a hydraulic power unit 104. The hydraulic power unit 104 consists of a fluid reservoir 101, a pump 103, and motor 105 that form the hydraulic power unit 104.

Forward of the hydraulic power unit 104 in a bottom 107 of the motor housing 100 are located a plurality of solenoid actuated valves 106. Each solenoid actuated valve 106 consists of a valve body, two solenoids, and an interior cartridge. The solenoid actuated valves 106 are hydraulically coupled to the hydraulic power unit 104. The solenoid actuated valves 106 are also hydraulically coupled to hydraulic cylinders 110, 202, 216, and 310.

At a front end 109/bottom side 107 of the motor housing 100 a dual rod extend/retract piston 110 can be mounted to the rotational housing 200. The dual rod extend/retract piston 110 can be attached to the rotational housing 200 by the rotational housing piston mount 204 and allows a horizontal extension or retraction of the rotational housing 200 while resisting the torque generated by the rotary actuator 202. Thus, the rotational housing 200 is in front of the motor housing 100.

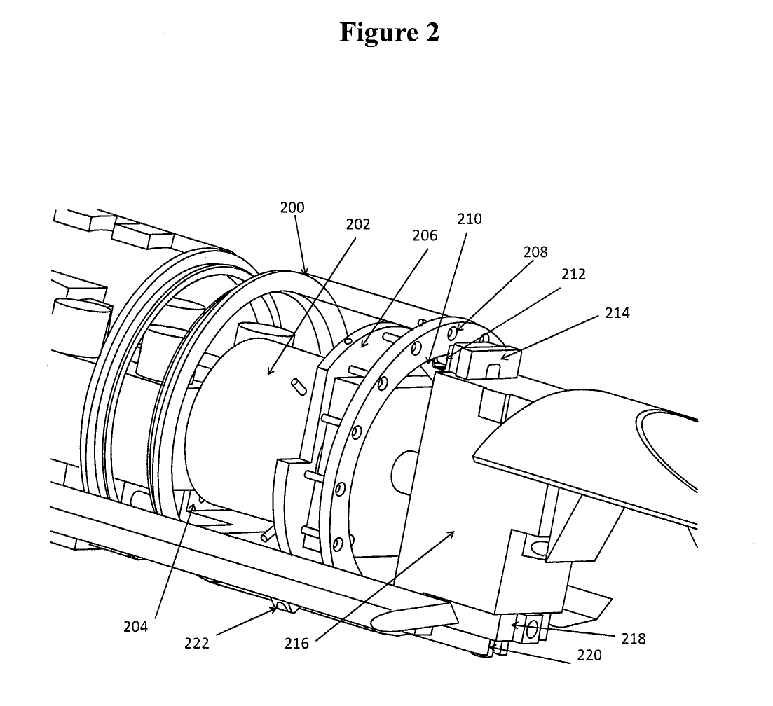

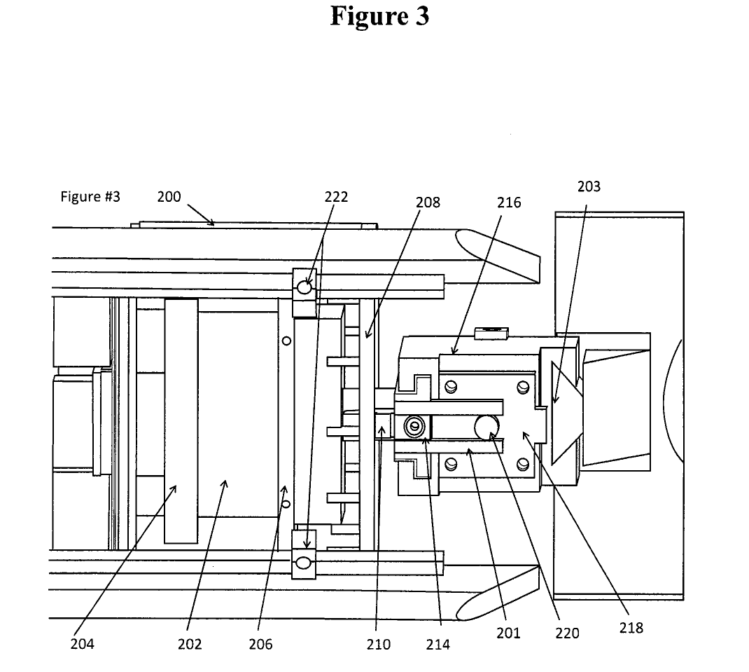

FIGS. 2 and 3 illustrate that inside the rotational housing 200 is attached a rotary actuator mount 206. A rotary actuator 202 is attached to the rotary actuator mount 206 with its keyed shaft protruding from the end of the rotational housing 200. A rotational race 208 is attached to the front of the rotational housing 200. A T-slider 214 is then slid onto and keyed to the shaft of the rotary actuator 202. Mounted in the slots at each end of the T-slider 214 are forks 210.

The slots on the end of the forks 210 in turn engage with the rotational race 208 securing the T-slider 214 on the shaft of the rotary actuator 202 and providing a resisting moment created by the actuation of the radial piston 216. The radial piston 216 slides onto the T-slider 214 and a piston plunger 220 engages the tines 201 of the T-Slide 214.

A piston cap 218 engages to a bottom of the radial piston 216 creating the seal needed for piston actuation. The front most side of the radial piston 216 contains a dovetail 203 that allows for the placement of attachments. In the current embodiment, attached is the lateral lining attachment 12 that allows the placement of a lateral lining system.

Attached to the bottom of the rotational housing are lift supports 222 that engage with skis 114 to prevent excessive torque on the extend and retract piston 110 rods. The skis 114 are mounted to the bottom of the motor housing 100 and can be used to center the unit 10 in the enclosed space, like a pipe, and providing a lateral slide surface for the rotational housing 200.

The skis 114 are for one embodiment, other elements to assist in the unit traversing the enclosed space can be motorized or free-wheeling wheels, treads or any other type of propulsion. In one embodiment, the unit is “threaded” through the pipe line by the use of high strength cables attached to the front and rear of the unit 10 to pull the unit 10 in the forward and reverse directions in the pipe line or other enclosed space. Additionally, the hydraulic power unit 104 can be diverted to drive a linear propulsion system to drive the unit 10.

FIG. 1 illustrates that in a space above the extend/retract piston 110 are located at least one DC power supply 112. The DC power supply 112 supplies the power to the cameras 302 and other DC accessories. In the approximate middle of the motor housing 100 there is a cut-out 111 allowing the necessary space for the clamp housing 300. The clamp mounting plate 108 is mounted to the motor housing 100 and in turn the clamp housing 300 is mounted to the clamp mounting plate 108.

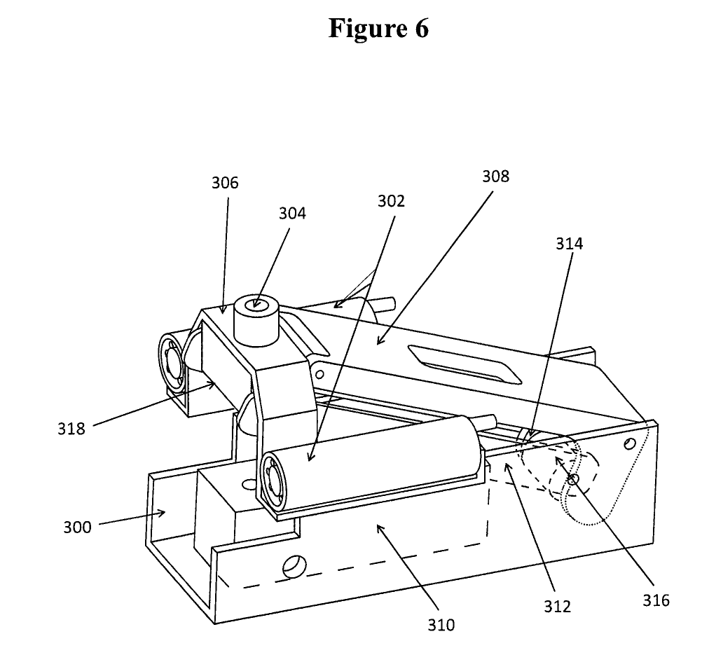

FIG. 6 illustrates that the clamp housing 300 houses the clamp assembly. The clamp assembly can include an L-linkage 308, two long linkage arms 312, two short linkage arms 314, a barrel linkage 316, a clamp piston 310, a platform linkage 318, a camera bracket 306, and at least one camera 302.

The clamp piston 310 can be mounted to the clamp housing 300 and the barrel linkage 316 can be threaded onto the plunger of the clamp piston 310. The barrel linkage 316 has a round protrusion on each side that engages one side of each of the short linkage arm 314. The other side of the short linkage arm is connected to the rear bottom hole of the L-linkage 308. The rear top hole of the L-linkage 308 is connected to the rear top hole in the clamp housing 300. The rear top hole of the platform linkage 318 is connected to the front hole of the L-linkage 308 and the front bottom hole of the platform linkage 318 is connected to the front of the two long arm linkages 312. The rear holes of the two long arm linkages 312 are connected to the lower rear holes in the clamp housing 300.

The camera bracket 306 is secured to the platform linkage 318. The camera 302 is secured to the camera bracket 306. By extending or retracting the clamp piston 310, this four bar linkage allows the platform linkage 318 to be lowered or raised maintaining the camera bracket 306 level throughout the motion. The clamp is used to lock the unit into the pipe to resist any forces developed by the actuation of any of the degrees of motion.

In one embodiment, a clamp surface 304 sits atop platform linkage 318 and/or camera bracket 306. The clamp surface 304 engages the upper surface of the enclosed space to anchor the unit 10 in place. Once the clamp surface 304 is engaged, the pressure to the clamp piston 310 can be fixed by closing its solenoid actuated valve 106 allowing a secure engagement. Once the unit 10 is ready for further travel along the pipe line, the clamp piston's 310 solenoid actuated valve 106 can be opened to allow disengagement.

In one embodiment, both the clamp surface 304 and the camera 302 are mounted to camera bracket 306. When platform linkage 318 is actuated by the clamp piston 310 both the clamp surface 304 and the camera 302 can move at the same time. Once the movement on the camera stops, a technician operating the unit 10 can easily appreciate that the clamp surface 304 is engaged with the wall of the enclosed space or fully retracted into the clamp housing 300.

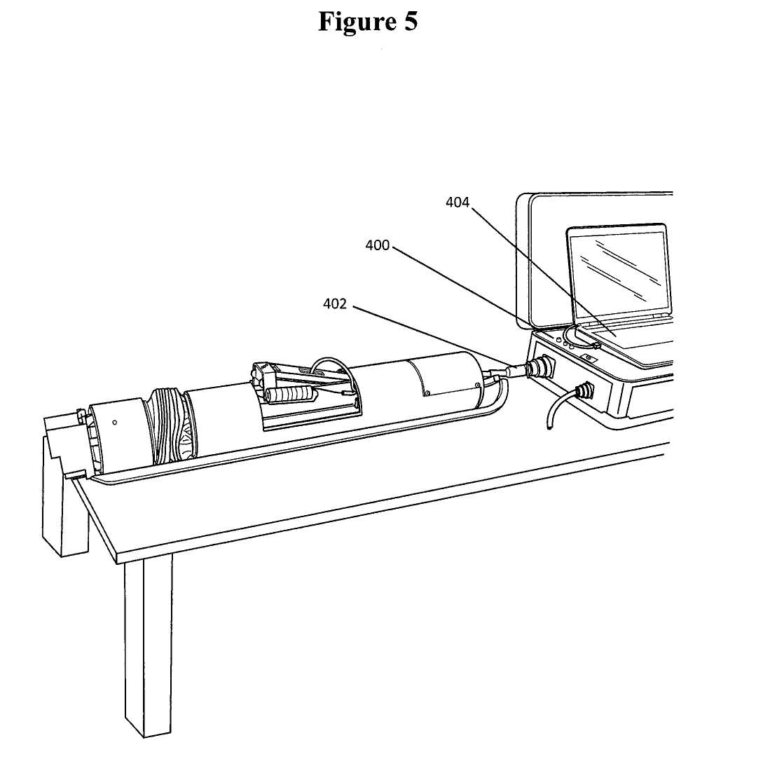

All electrical components (i.e. motor, solenoids, D)C power supplies) are wired into a control cable 402 that is then connected to the control box 400. The control box contains micro control boards that are controlled by a CPU (laptop 404) allowing the actuation of the self enclosed hydraulic system. See FIG. 5.

Thus, the unit 10 requires a minimum of wires and no external hydraulic hoses to perform the necessary tasks inside the enclosed space. In a particular embodiment for entering the unit into a pipe line that is at least 8 inches in diameter, the unit 10, as defined by the motor housing 100 can have an overall length of less than approximately 36 inches and approximately less than 6 inches in diameter not including the skis. In particular, the diameter can be approximately 5.5 inches in diameter. This allows the unit to enter a pipeline though a manhole cover, which are approximately 22 inches to 36 inches in diameter and the manhole proper typically expands to 48 inches to 60 inches near the pipe line. Further, the unit can be configured to enter pipe lines of any diameter, most particularly 8, 10, 12, and 16 inch diameter pipe.

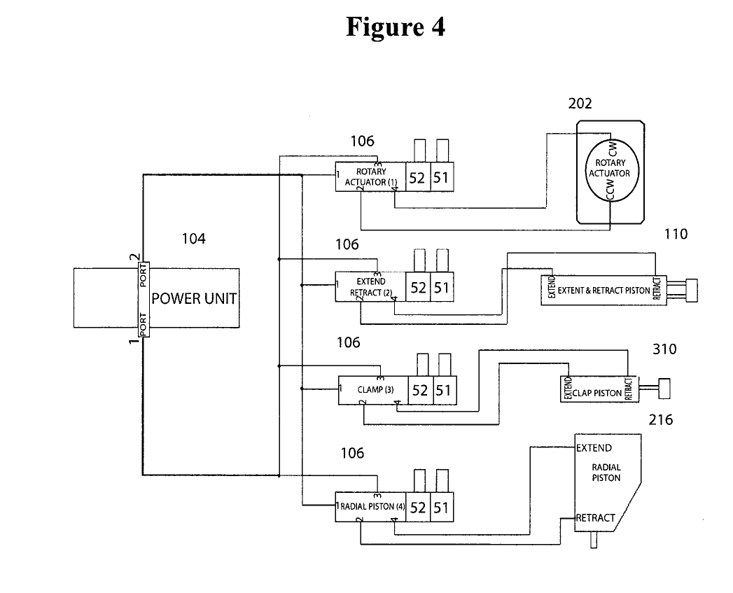

In one embodiment, the hydraulic power unit 104 provides at least 25 psi hydraulic fluid to the hydraulic system. Each solenoid actuated valve 106 can be no bigger than 1.25×1.65×6.57 inches. The solenoid actuated valves 106 can all be 4 way 3 position valves allowing all of the hydraulic cylinders to be hydraulically actuated in both directions. The hydraulic power unit 104, the solenoid actuated valves 106, and the hydraulic cylinders can all be connected by 3/16 inch nylon tubing and compression fittings (see FIG. 4). Additionally, since an embodiment is designed to enter a pipe line, a hydraulic fluid to be used in the hydraulic power unit can be any biodegradable or food quality oil, including canola, vegetable, olive, sunflower and corn oils. Depending on the nature of the enclosed space, most non-compressible, non-corrosive, fluids can be used.

The hydraulic system described in FIG. 4 operates as follows: The hydraulic power 104 pumps hydraulic fluid into the supply line that is attached to port 1 on all of the solenoid actuated valves 106. The solenoid actuated valves 106 are normally closed disallowing fluid to move through the ports. Upon actuation fluid flows from the supply line into port 1 and out of port 2 or 4 into the selected end of one of the hydraulic actuators 110, 202, 216, or 310. As the hydraulic actuator moves through its stroke, fluid is displaced out of the opposite side of the actuator. This fluid enters the solenoid actuated valve through port 2 or 4 and out of port 3 into the return line that returns the fluid back to the hydraulic power unit's 104 reservoir 101.

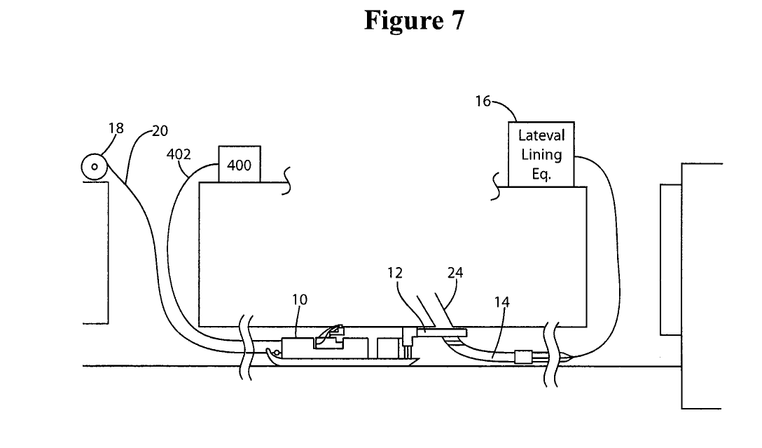

The function of the unit operating in a sewer lining operation operates as follows, also see FIG. 7:

The unit 10 is placed in pipe line and winched 18 using a tow cable 20 into a position, in this particular embodiment, the unit is positioned by a “lateral” connection 24 into a sewer pipe. A lateral connection 24 can enter the sewer pipe approximately anywhere within the top 180° arc of the sewer pipe. Once positioned, solenoid actuated valve 106 for the clamp piston 310 is actuated open and the clamp piston 310 extends, forcing clamp surface 304 to engage the surface of the sewer pipe and then the valve 106 is closed. Hydraulic power is now diverted to at least one of extend/retract piston 110, the rotary actuator 202, and the radial piston 216. The combination of the movements allowed by the three interconnected pistons/actuators allows for three degrees of motion and permits the lateral lining attachment 12 to line up with the lateral 24. Once the lateral lining attachment is lined up the solenoid actuated valves 106 are closed, locking the lateral lining attachment in place allowing the deployment of the lateral lining system.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

We claim:

1. A remote controlled unit comprising:
a housing sized to pass through an enclosed space having a diameter smaller than or equal to approximately 16 inches;
an actuation device permitting three degrees of motion about an axis attached to an end of the housing; and
a hydraulic system fully enclosed in the housing, capable of generating at least 25 psi system pressure, and hydraulically coupled to the actuation device to provide a force.

2. The unit according to claim 1, wherein the three degrees of motion comprise:
a longitudinal motion along an axis of the housing;
a radial motion approximately perpendicular to the axis of the housing; and
a rotational motion about the axis of the housing.

3. The unit according to claim 1, wherein the hydraulic system includes a motor, a pump, a reservoir, a plurality of 4 way 3 position valves, and flexible nylon tubing.

4. The unit according to claim 3, wherein: the plurality of 4 way 3 position valves are less than or equal to 1.25×1.65×6.57 inches.

5. The unit according to claim 1, wherein a diameter of the housing is less than or equal to approximately 6 inches and less than or equal to approximately 36 inches in length.

6. The unit according to claim 1, wherein the actuation device comprises:
a hydraulic piston having an integrated linear race and a dovetail allowing an extension of at least one attachment to the unit.

7. The unit according to claim 1, further comprising:
a clamping unit disposed in the housing and hydraulically coupled to the hydraulic unit,
wherein the clamping unit is hydraulically extended to engage a surface of the enclosed space to anchor the unit.

8. The unit according to claim 7, wherein the clamping unit includes a hydraulically actuated four bar linkage.

9. The unit according to claim 1, wherein the actuation device further comprises:
a rotational race; and
an actuator shaft,
wherein moment forces created from radial extension and towing of the unit are transferred to both the rotational race and the actuator shaft.

10. The unit according to claim 1, further comprising a dual rod piston used to resist torque created during rotation.

11. The unit according to claim 1, wherein the hydraulic unit uses food grade oil as hydraulic fluid.
